(19) United States
(12) Patent Application Publication
(10) Pub. No.: US 2021/0326649 A1
(43) Pub. Date: Oct. 21, 2021

(54) CONFIGURATION METHOD AND APPARATUS FOR DETECTOR, STORAGE MEDIUM

(71) Applicant: Beijing Sensetime Technology Development Co., Ltd., Beijing (CN)

(72) Inventors: Junran PENG, Beijing (CN); Ming Sun, Beijing (CN)

(21) Appl. No.: 17/360,000

(22) Filed: Jun. 28, 2021

Related U.S. Application Data
(63) Continuation of application No. PCT/CN2019/119161, filed on Nov. 18, 2019.

(30) Foreign Application Priority Data
Aug. 30, 2019 (CN) 201910816321.1

(51) Int. Cl. G06K 9/62; G06T 5/30

(52) U.S. Cl. CPC G06K 9/6256; G06T 5/30; G06K 9/6262; G06N 20/00; G06T 2207/20084; G06K 2209/21; G06T 2207/20081

(57) ABSTRACT

A configuration method and apparatus for a detector, an electronic device, and a storage medium. The method comprises: determining a fixed dilation rate of a convolution operation of dilation convolution in a detector (S11); performing the convolution operation of the dilation convolution on any one of the detectors, and when the fixed dilation rate of the convolution operation meets a decomposition condition, decomposing the convolution operation into a first sub convolution operation and a second sub convolution operation, determining an upper-limit dilation rate and a lower-limit dilation rate corresponding to the fixed dilation rate of the convolution operation, using the upper-limit dilation rate as the dilation rate of the first sub convolution operation, and using the lower-limit dilation rate as the dilation rate of the second sub convolution operation (S12); and according to the number of output channels of the convolution operation and the fixed dilation rate of the convolution operation, determining the number of the output channels corresponding to the first sub convolution operation and the number of the output channels corresponding to the second sub convolution operation (S13). The detector obtained by means of the method can reduce the time required for target detection, and thus can be applicable to a real-time scene.

The present application is a continuation of and claims priority under 35 U.S.C. § 120 to PCT Application. No. PCT/CN2019/119161, filed on Nov. 18, 2019, which is based upon and claims the benefit of a priority to Chinese Patent Application No. 201910816321.1, filed with the Chinese Patent Office on Aug. 30, 2019, entitled “Detector Configuring Method and Apparatus, Electronic Device and Storage Medium”. All the above referenced priority documents are incorporated herein by reference.

### TECHNICAL FIELD

The present disclosure relates to the technical field of computer vision, and in particular to a detector configuring method and apparatus, a target detection method and apparatus, an electronic device and a storage medium.

### BACKGROUND

As a very important and basic technique in computer vision, target detection aims at detecting the position and category of targets in images. Target detection technology plays an important role in many fields, such as pedestrian and vehicle detection in automatic driving, living body detection in smart home, pedestrian detection in security monitoring and so on. In face recognition, identity recognition, target tracking and other such tasks, in order to lock targets or provide initial frames, target detection is absolutely necessary as well. In practical application scenarios, target scales vary vastly and have different sizes.

### SUMMARY

The present disclosure presents a target detection technical solution.

According to an aspect of the present disclosure, a detector configuring method is provided, which comprises:
determining a fixed dilation rate of a convolution operation for performing dilation convolution in a detector;
for any convolution operation for performing dilation convolution in the detector, in response to the fixed dilation rate of the convolution operation satisfying a decomposition condition, decomposing the convolution operation into a first sub-convolution operation and a second sub-convolution operation, determining an upper limit dilation rate and a lower limit dilation rate corresponding to the fixed dilation rate of the convolution operation, wherein the upper limit dilation rate is a dilation rate of the first sub-convolution operation, and the lower limit dilation rate is a dilation rate of the second sub-convolution operation; and
determining a number of output channels corresponding to the first sub-convolution operation and a number of output channels corresponding to the second sub-convolution operation according to a number of output channels of the convolution operation and the fixed dilation rate of the convolution operation.

A detector configuring apparatus, comprising:
a first determination module used for determining a fixed dilation rate of a convolution operation for performing dilation convolution in a detector;
a second determination module used for: for any convolution operation for performing dilation convolution in the detector, in response to the fixed dilation rate of the convolution operation satisfying a decomposition condition, decomposing the convolution operation into a first sub-convolution operation and a second sub-convolution operation, determining an upper limit dilation rate and a lower limit dilation rate corresponding to the fixed dilation rate of the convolution operation, wherein the upper limit dilation rate is a dilation rate of the first sub-convolution operation, and the lower limit dilation rate is a dilation rate of the second sub-convolution operation; and
a third determination module used for determining a number of output channels corresponding to the first sub-convolution operation and a number of output channels corresponding to the second sub-convolution operation according to a number of output channels of the convolution operation and the fixed dilation rate of the convolution operation.

According to an aspect of the present disclosure, an electronic device is provided, which comprises:
one or more processors; and
a memory associated with the one or more processors for storing executable instructions that, when read for execution by the one or more processors, perform the detector configuring method described above.

According to an aspect of the present disclosure, there is provided a computer readable storage medium having stored thereon computer program instructions which, when executed by a processor, implement the above-mentioned detector configuring method.

According to an aspect of the present disclosure, there is provided a computer program comprising computer readable codes which, when run in an electronic device, are executed by a processor in the electronic device for implementing the above-mentioned method.

It is to be understood that both the foregoing general description and the following detailed description are exemplary and explanatory only, and are not restrictive of the disclosure.

Other features and aspects of the present disclosure will become apparent from the following detailed description of exemplary embodiments, which proceeds with reference to the accompanying drawings.

### BRIEF DESCRIPTION OF THE DRAWINGS

The accompanying drawings, which are incorporated in and constitute a part of this description, illustrate embodiments consistent with the disclosure and, together with the description, serve to explain the technical solution of the present disclosure.

FIG. 1 is a flowchart showing a detector configuring method provided by an embodiment of the present disclosure.

FIG. 2 is a schematic diagram showing a dilation rate learner in a detector configuring method provided by an embodiment of the present disclosure.

FIG. 3 is a schematic diagram showing the number of output channels corresponding to the first sub-convolution operation Convᵤ and the number of output channels corresponding to the second sub-convolution operation Convₗ in a detector configuring method provided by an embodiment of the present disclosure.

FIG. 4 is a schematic diagram showing decomposition of a convolution operation for performing dilation convolution in a detector into two sub-convolution operations Convᵤ and Convₗ, in a detector configuring method provided by an embodiment of the present disclosure.

FIG. 5 is a schematic diagram showing a detector configuring method provided by an embodiment of the present disclosure.

FIG. 6 is a block diagram showing a detector configuring apparatus provided by an embodiment of the present disclosure.

FIG. 7 is a block diagram showing an electronic device 800 provided by an embodiment of the present disclosure.

FIG. 8 is a block diagram showing an electronic device 1900 provided by an embodiment of the present disclosure.

### DETAILED DESCRIPTION

Various exemplary embodiments, features and aspects of the present disclosure are described in details below with reference to the accompanying drawings. Like reference symbols in the drawings indicate functionally identical or similar elements. While various aspects of the embodiments are shown in the drawings, the drawings are not necessarily drawn to scale unless otherwise indicated.

The word “exemplary” is used exclusively herein to mean “serving as an example, embodiment, or illustration”. Any embodiment described herein as “exemplary” is not necessarily to be construed as preferred or advantageous over other embodiments.

The term “and/or” herein is merely an association that describes an associated object, meaning that there may be three relationships, e.g., A and/or B, that may represent: there are three cases of A alone, A and B simultaneously, and B alone. In addition, the term “at least one” herein means any combination of at least two of any one or more of a plurality, e.g., including at least one of A, B and C, may mean to include any one or more elements selected from a group consisting of A, B, and C.

Further, in the following detailed description, numerous specific details are set forth in order to provide a better understanding of the present disclosure. It will be understood by a person skilled in the art that the present disclosure may be practiced without some of the specific details. In some instances, methods, means, elements, and circuits well known to a person skilled in the art have not been described in detail so as not to obscure the subject matter of the present disclosure.

In order to solve the technical problems similar to those described above, the embodiments of the present disclosure provide a detector configuring method and apparatus, an object detection method and apparatus, an electronic device, and a storage medium, so as to shorten the time required for object detection, and thereby achieve applicability to real-time scenarios.

FIG. 1 is a flowchart showing a detector configuring method provided by an embodiment of the present disclosure. The execution entity for the detector configuring method may be a detector configuring apparatus. For example, the detector configuring method may be performed by a terminal device or a server or other processing devices. Among them, the terminal device may be a user equipment (UE), a mobile device, a user terminal, a terminal, a cellular telephone, a cordless telephone, a personal digital assistant (PDA), a handheld device, a computing device, a vehicle-mounted device, or a wearable device, etc. In some possible implementations, the detector configuring method may be implemented in such a manner that a processor calls computer readable instructions stored in a memory. As shown in FIG. 1, the detector configuring method includes steps S11 to S13.

Prior to step S11, the type of the detector and the subject network of the detector may be determined. For example, the type of the detector may be Faster-RCNN, RFCN, RetinaNet, SSD or the like, and the subject network of the detector may be VGG, ResNet, ResNeXt or the like.

In step S11, a fixed dilation rate of a convolution operation for performing dilation convolution in a detector is determined.

In the embodiment of the present disclosure, there may be one or more convolution operations performing dilation convolution in the detector. For example, the convolution operation for performing dilation convolution in the detector may be part or all of the convolution operations in the detector. That is, the detector may include a convolution operation for performing dilation convolution, and may also include a convolution operation performing no dilation convolution.

In the embodiment of the present disclosure, the same convolution operation of the detector may have different or the same dilation rate for different training images. The different convolution operations of the detector may have different or the same dilation rate for the same training image.

In one possible implementation, if the convolution kernel of the convolution operation includes two dimensions, the dilation rate of the convolution operation may comprise a longitudinal dilation rate and a transverse dilation rate. Wherein the longitudinal dilation rate and the transverse dilation rate of the convolution operation may be different or the same. For example, the fixed dilation rate may include a longitudinal fixed dilation rate and a transverse fixed dilation rate. Accordingly, the first dilation rate hereinafter may include a first longitudinal dilation rate and a first transverse dilation rate, and the second dilation rate may include a second longitudinal dilation rate and a second transverse dilation rate. By configuring the dilation rates corresponding to different dimensions of the convolution operation, the convolution kernel size of the convolution operation in the detector can be more flexible, and the resultant detector can further improve the accuracy of target detection.

In another possible implementation, the dilation rate of the convolution operation may not be divided into the longitudinal dilation rate and the transverse dilation rate. In this implementation, the longitudinal dilation rate and the transverse dilation rate of the convolution operation may be the same by default, i.e. the dilation rates of different dimensions of the convolution operation may be the same by default.

In one possible implementation, dilated convolution kernel size=dilation rate×(original convolution kernel size−1)+1. For example, if the dilation rate of the convolution operation for the training image includes a longitudinal dilation rate and a transverse dilation rate, the dilated convolution kernel longitudinal size=longitudinal dilation rate×(original convolution kernel longitudinal size−1)+1, and the dilated convolution kernel transverse size=transverse dilation rate×(original convolution kernel transverse size−1)+1.

In one possible implementation, the detector comprises a subject network; the convolution operation for performing dilation convolution in the detector comprises: one or more convolution operations in which an original convolution kernel size is a designated size in the subject network of the detector. For example, the designated size may include 3×3, or the designated size may include 5×5, 7×7, etc.

As an example of this implementation, the convolution operation for performing dilation convolution in the detector comprises: all convolution operations in which an original convolution kernel size is a designated size in the subject network of the detector. For example, the subject network is ResNet, and the convolution operation for performing dilation convolution in the detector may include all 3×3 convolution operations in conv2, conv3, conv4, and conv5 of ResNet.

As another example of this implementation, the convolution operation for performing dilation convolution in the detector includes: a partial convolution operation in which the original convolution kernel size is a designated size in the subject network of the detector. For example, the convolution operation for performing dilation convolution in the detector may include: one or more convolution operations in which the original convolution kernel size is a designated size in designated convolution layers of the subject network of the detector. For example, the subject network is ResNet, and the designated convolution layers may be conv3, conv4 and conv5, and the convolution operation for performing dilation convolution in the detector may include all 3×3 convolution operations in conv3, conv4 and conv5 of ResNet. In this example, the convolution operation for performing dilation convolution in the detector may not include the 3×3 convolution operation in conv2.

In another possible implementation, the convolution operation for performing dilation convolution in the detector may include: convolution operations in designated convolution layers in the subject network of the detector. For example, the subject network is ResNet, and the convolution operation for performing dilation convolution in the detector may include convolution operations in conv2, conv3, conv4 and conv5.

In another possible implementation, the convolution operation for performing dilation convolution in the detector may further include: convolution operations outside of the subject network in the detector. For example, the convolution operation for performing dilation convolution in the detector may also include a convolution operation in which the original convolution kernel size is a designated size outside of the subject network in the detector.

In one possible implementation, the detector further includes a dilation rate learner; determining a fixed dilation rate of a convolution operation for performing dilation convolution in a detector comprises: obtaining a first dilation rate of the convolution operation for a plurality of training images through the dilation rate learner; and determining the fixed dilation rate of the convolution operation according to the first dilation rate. In this implementation, the fixed dilation rate of the convolution operation is determined according to the first dilation rate of the convolution operation for a plurality of training images, so that the accuracy of the determined fixed dilation rate is high, and thus the accuracy of target detection by the detector can be guaranteed.

In this implementation, the dilation rate learner may be used to learn the dilation rate of the convolution operation for the training image. The dilation rate learner may be in one-to-one correspondence with the convolution operation for performing dilation convolution in the detector. That is, one dilation rate learner may be used to learn the dilation rate of one convolution operation for performing dilation convolution. In this implementation, the dilation rate learner may be disposed between the convolution operation for performing dilation convolution and the previous operation of the convolution operation for performing dilation convolution.

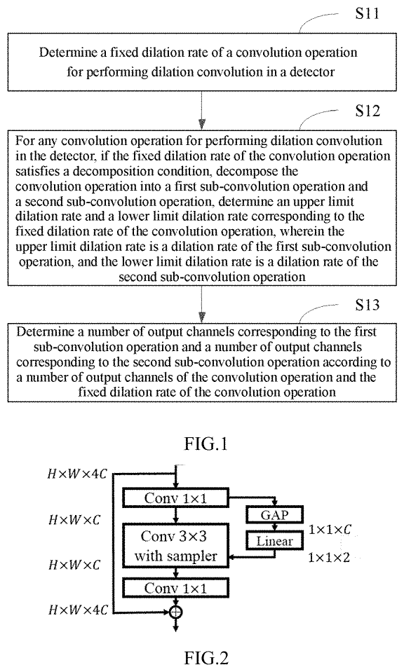

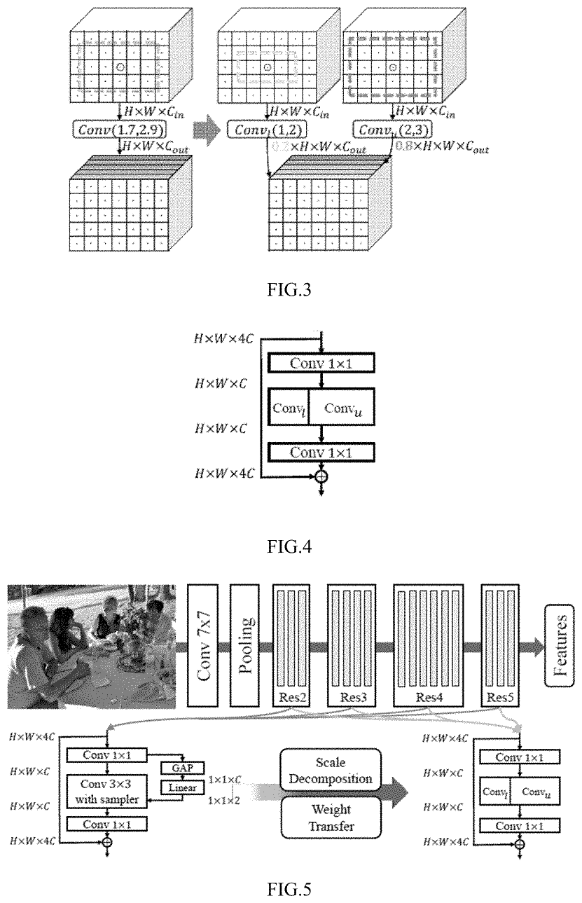

As an example of this implementation, the dilation rate learner includes a global average pooling layer and a fully connected layer. For example, the dilation rate learner may include one global average pooling layer and one fully connected layer. In this example, a first dilation rate of the convolution operation for a plurality of training images may be obtained by a global averaging pooling operation and a full connection operation. For example, for any convolution operation for performing dilation convolution in the detector, the dilation rate of the convolution operation for the training image may be predicted through the global averaging pooling operation and the full connection operation of a feature prior to the convolution operation (i.e. the input feature image of the convolution operation in an initial structure of the detector). FIG. 2 is a schematic diagram showing a dilation rate learner in a detector configuring method provided by an embodiment of the present disclosure. As shown in FIG. 2, the dilation rate learner may include a Global Average Pooling (GAP) layer and a fully connected layer. Here, the fully connected layer may be a linear layer. As shown in FIG. 2, for any convolution operation for performing dilation convolution in a detector, the global average pooling layer and the fully connected layer may be respectively concatenated before the convolution operation and the convolution operation is replaced with deformable convolution, and the convolution operation is performed using the predicted dilation rate.

As an example of this implementation, obtaining a first dilation rate of the convolution operation for a plurality of training images through the dilation rate learner includes: for any training image in the plurality of training images, obtaining a second dilation rate of the convolution operation for the training image through the dilation rate learner; obtaining a target detection result corresponding to the training image based on the second dilation rate; updating parameters of the dilation rate learner according to the target detection result corresponding to the training image; and obtaining the first dilation rate of the convolution operation for the training image through the parameter-updated dilation rate learner.

In this example, for any training image in the plurality of training images, an dilated convolution kernel size corresponding to each of the convolution operations for performing dilation convolution in the detector may be determined according to the second dilation rate of each of the convolution operations for performing dilation convolution for the training image, and the target detection result corresponding to the training image may be obtained based on the dilated detector. Wherein the target detection result corresponding to the training image may include position information of a target detection frame in the training image and probabilities that the training image belongs to each classification. According to the target detection result corresponding to the training image and a real value of the training image, the value of a loss function of the detector may be obtained, so that the parameters of the dilation rate learner can be updated according to the value of the loss function of the detector. Wherein the number of times of training the dilation rate for any training image may be a preset value, for example, the preset value may be 13; alternatively, training may be performed for any training image until the dilation rate converges. In this example, multi-round learning by the dilation rate learner can improve the accuracy of the first dilation rate for determining the fixed dilation rate, thus improving the accuracy of the determined fixed dilation rate and further ensuring the accuracy of target detection by the detector.

In this example, the first dilation rate of the convolution operation for the training image may refer to a dilation rate of the convolution operation for the training image after the training for the training image is completed. That is, the first dilation rate of the convolution operation for the training image may refer to a dilation rate of the convolution operation for the training image after the number of times of training of the dilation rate for the training image reaches a preset value, or a dilation rate of convergence of the convolution operation for the training image.

In this example, the detector separately trains the dilation rates for different training images, and thus for any convolution layer for performing dilation convolution of the detector, a plurality of first dilation rates corresponding to a plurality of training images can be obtained.

As an example of this implementation, then determining the fixed dilation rate of the convolution operation according to the first dilation rate includes: determining the average value of the first dilation rate as the fixed dilation rate of the convolution operation. For example, if the fixed dilation rate of the convolution operation includes a longitudinal fixed dilation rate and a transverse fixed dilation rate, the average value of the first longitudinal dilation rate of the convolution operation for a plurality of training images may be determined as the longitudinal fixed dilation rate of the convolution operation, and the average value of the first transverse dilation rate of the convolution operation for a plurality of training images may be determined as the transverse fixed dilation rate of the convolution operation. For example, the longitudinal fixed dilation rate is 1.7 and the transverse fixed dilation rate is 2.9.

In this example, for any convolution operation for performing dilation convolution in the detector, the fixed dilation rate of the convolution operation may be determined from the first dilation rate of the convolution operation for a part of the training images (e.g. 1000 training images). For example, for the first 3×3 convolution operation of conv3 of the detector, the fixed dilation rate of the convolution operation may be determined based on the first dilation rate of the convolution operation for 1000 training images. Alternatively, for any convolution operation for performing dilation convolution in the detector, the fixed dilation rate of the convolution operation may be determined based on the first dilation rate of the convolution operation for all of the training images.

In step S12, for any convolution operation for performing dilation convolution in the detector, if the fixed dilation rate of the convolution operation satisfies a decomposition condition, the convolution operation is decomposed into a first sub-convolution operation and a second sub-convolution operation, an upper limit dilation rate and a lower limit dilation rate corresponding to the fixed dilation rate of the convolution operation are determined, and the upper limit dilation rate is taken as the dilation rate of the first sub-convolution operation and the lower limit dilation rate is taken as the dilation rate of the second sub-convolution operation.

For example, the fixed dilation rate of the convolution operation is D, the upper limit dilation rate corresponding to the fixed dilation rate of the convolution operation is Du, and the lower limit dilation rate corresponding to the fixed dilation rate of the convolution operation is Dl.

In one possible implementation, the fixed dilation rate of the convolution operation satisfying the decomposition condition includes any one of the following: the fixed dilation rate of the convolution operation being a decimal; the minimum distance between the fixed dilation rate of the convolution operation and an integer being greater than a first threshold value, wherein the minimum distance between the fixed dilation rate of the convolution operation and the integer represents a distance between the fixed dilation rate of the convolution operation and the integer closest to the fixed dilation rate of the convolution operation.

As an example of this implementation, if the fixed dilation rate of the convolution operation includes a longitudinal fixed dilation rate and a transverse fixed dilation rate, then the fixed dilation rate of the convolution operation being a decimal may be: at least one of the longitudinal fixed dilation rate and the transverse fixed dilation rate of the convolution operation being a decimal.

As an example of this implementation, if the fixed dilation rate of the convolution operation includes a longitudinal fixed dilation rate and a transverse fixed dilation rate, then the minimum distance between the fixed dilation rate of the convolution operation and an integer being greater than a first threshold value may be: the minimum distance between at least one of the longitudinal fixed dilation rate and the transverse fixed dilation rate of the convolution operation and the integer being greater than the first threshold value. For example, if the first threshold value is 0.05, the longitudinal fixed dilation rate of a certain convolution operation is 2.02, and the transverse fixed dilation rate is 1.7, then the minimum distance between the longitudinal fixed dilation rate of the convolution operation and the integer is 0.02, which is smaller than the first threshold value, and the minimum distance between the transverse fixed dilation rate of the convolution operation and the integer is 0.3, which is greater than the first threshold value. Thus, it can be determined that the convolution operation satisfies the decomposition condition.

In one example, if the minimum distance between one of the longitudinal fixed dilation rate and the transverse fixed dilation rate of the convolution operation and the integer is smaller than or equal to the first threshold value, and the minimum distance between the other of the longitudinal fixed dilation rate and the transverse fixed dilation rate of the convolution operation and the integer is greater than the first threshold value, then decomposition may be performed according to the other of the longitudinal fixed dilation rate and the transverse fixed dilation rate. For example, if the convolution operation has a longitudinal fixed dilation rate of 2.02 and a transverse fixed dilation rate of 1.7, it is possible to obtain a first sub-convolution operation having a longitudinal dilation rate of 2 and a transverse dilation rate of 2, and a second sub-convolution operation having a longitudinal dilation rate of 2 and a transverse dilation rate of 1. According to this example, when the minimum distance between the integer and one of the longitudinal fixed dilation rate and the transverse fixed dilation rate of the convolution operation is smaller than or equal to the first threshold value, decomposition may not be performed for the one smaller than or equal to the first threshold value, and therefore the amount of calculation for detector configuration can be reduced.

In one possible implementation, determining an upper limit dilation rate and a lower limit dilation rate corresponding to the fixed dilation rate of the convolution operation includes: determining an integer greater than the fixed dilation rate of the convolution operation and closest to the fixed dilation rate of the convolution operation as the upper limit dilation rate corresponding to the fixed dilation rate of the convolution operation; and determining an integer smaller than the fixed dilation rate of the convolution operation and closest to the fixed dilation rate of the convolution operation as the lower limit dilation rate corresponding to the fixed dilation rate of the convolution operation. For example, if the longitudinal fixed dilation rate is 1.7 and the transverse fixed dilation rate is 2.9, then the longitudinal upper limit dilation rate can be determined to be 2, the longitudinal lower limit dilation rate can be determined to be 1, the transverse upper limit dilation rate can be determined to be 3, and the transverse lower limit dilation rate can be determined to be 2. In this example, the longitudinal upper limit dilation rate of 2 and the transverse upper limit dilation rate of 3 can be determined as the dilation rate of the first sub-convolution operation, and the longitudinal lower limit dilation rate of 1 and the transverse lower limit dilation rate of 2 can be determined as the dilation rate of the second sub-convolution operation.

In the embodiment of the present disclosure, the convolution operation is decomposed into a first sub-convolution operation and a second sub-convolution operation if the fixed dilation rate of the convolution operation satisfies a decomposition condition. For example, the convolution operation is decomposed into a first sub-convolution operation and a second sub-convolution operation having an integer dilation rate if the fixed dilation rate of the convolution operation is a decimal. Therefore, the introduction of bilinear interpolation operations can be reduced during a convolution calculation process, and thus the calculation speed can be improved.

In step S13, the number of output channels corresponding to the first sub-convolution operation and the number of output channels corresponding to the second sub-convolution operation are determined according to the number of output channels of the convolution operation and the fixed dilation rate of the convolution operation.

For example, the number of output channels of the convolution operation is C, the number of output channels corresponding to the first sub-convolution operation is Cu, and the number of output channels corresponding to the second sub-convolution operation is Cl.

In one possible implementation, determining the number of output channels corresponding to the first sub-convolution operation and the number of output channels corresponding to the second sub-convolution operation according to the number of output channels of the convolution operation and the fixed dilation rate of the convolution operation includes: determining an overall difference coefficient corresponding to the convolution operation according to a difference between the fixed dilation rate of the convolution operation and the lower limit dilation rate; and determining the number of output channels corresponding to the first sub-convolution operation and the number of output channels corresponding to the second sub-convolution operation according to the number of output channels of the convolution operation and the overall difference coefficient corresponding to the convolution operation.

In this implementation, the overall difference coefficient corresponding to the convolution operation may be determined based on the difference D−Dl between the fixed dilation rate D of the convolution operation and the lower limit dilation rate Dl.

As an example of this implementation, if the fixed dilation rate of the convolution operation includes a longitudinal fixed dilation rate and a transverse fixed dilation rate, then a first difference between the longitudinal fixed dilation rate of the convolution operation and the longitudinal lower limit dilation rate may be determined, a second difference between the transverse fixed dilation rate of the convolution operation and the transverse lower limit dilation rate may be determined, and an average value of the first difference and the second difference may be used as the overall difference coefficient corresponding to the convolution operation. For example, the fixed dilation rate of the convolution operation includes a longitudinal fixed dilation rate of 1.7 and a transverse fixed dilation rate of 2.9, the first difference a_{longitudinal} between the longitudinal fixed dilation rate of 1.7 of the convolution operation and the longitudinal lower limit dilation rate of 1 is a_{longitudinal}=0.7, and the second difference aₜᵣₐₙₛᵥₑᵣₛₑ between the transverse fixed dilation rate of 2.9 of the convolution operation and the transverse lower limit dilation rate of 2 is aₜᵣₐₙₛᵥₑᵣₛₑ=0.9, then the overall difference coefficient corresponding to the convolution operation is a=0.8.

For example, the number of output channels corresponding to the first sub-convolution operation is Cu=aC, and the number of output channels corresponding to the second sub-convolution operation is Cl=(1−a) C.

FIG. 3 is a schematic diagram showing the number of output channels corresponding to the first sub-convolution operation Convᵤ and the number of output channels corresponding to the second sub-convolution operation Convₗ in a detector configuring method provided by an embodiment of the present disclosure. In FIG. 3, the first sub-convolution operation Convᵤ has a longitudinal dilation rate of 2 and a transverse dilation rate of 3, and the second sub-convolution operation Conv₁ has a longitudinal dilation rate of 1 and a transverse dilation rate of 2. H×W×Cᵢₙ represents height, width and the number of channels of the input feature maps of the convolution operation, so that height, width and the number of channels of the input feature maps of the first sub-convolution operation Convᵤ and the second sub-convolution operation Conv₁ also conform to H×W×Cᵢₙ. Cₒᵤₜ represents the number of output channels of the convolution operation, and the convolution operation has a longitudinal fixed dilation rate of 1.7 and a transverse fixed dilation rate of 2.9. The number of output channels corresponding to the first sub-convolution operation Convᵤ is 0.8, and the number of output channels corresponding to the second sub-convolution operation Convₗ is 0.2.

Of course, in another possible implementation, the overall difference coefficient corresponding to the convolution operation may also be determined based on the difference between the fixed dilation rate of the convolution operation and the upper limit dilation rate.

In the embodiment of the present disclosure, the convolution operation for performing dilation convolution in the detector is decomposed, so that the time-consuming bilinear interpolation operations can be reduced during a convolution calculation process, the calculation speed can be improved, the time required for target detection can be shortened, and the method can be suitable for real-time scenarios.

In one possible implementation, after the number of output channels corresponding to the first sub-convolution operation and the number of output channels corresponding to the second sub-convolution operation are determined, a step that the detector is trained with a target training image set to optimize parameters of the detector is further included.

In this implementation, after the number of output channels corresponding to the first sub-convolution operation and the number of output channels corresponding to the second sub-convolution operation are determined, the dilation rate learner may no longer be included in the detector, and the convolution operation for performing dilation convolution in the detector may be decomposed into two sub-convolution operations. FIG. 4 is a schematic diagram showing decomposition of a convolution operation for performing dilation convolution in a detector into two sub-convolution operations Convᵤ and Convₗ, in a detector configuring method provided by an embodiment of the present disclosure.

FIG. 5 is a schematic diagram showing a detector configuring method provided by an embodiment of the present disclosure. As shown in FIG. 5, the subject network of the detector is ResNet, 3×3 convolution operations in Res2, Res3, Res4 and Res5 are decomposed, and each 3×3 convolution operation in Res2, Res3, Res4 and Res5 is decomposed into two sub-convolution operations, respectively.

In one possible implementation, when the detector is trained, SGD may be used as a learning optimizer, with a momentum of 0.9, a weight decay rate set to 0.0001, and an initial learning rate of 0.00125 per training image. The training time may be set to 13 cycles, and the learning rate may be decreased after the 8th cycle and the 11th cycle by a factor of 10.

The detector configuring method provided by the embodiment of the present disclosure can be suitable for a scenario in which hard coding is required, removes an adaptive module on the premise of ensuring that multi-scale targets can be processed, and achieves the effects of reducing time consumption and improving detection speed. In addition, compared with adaptive methods, the hard coding method provided by the embodiment of the present disclosure can accelerate compatibility with hardware and is beneficial to practical applications.

The embodiment of the present disclosure also provides a target detection method, which comprises: acquiring an image to be detected; performing, by using the detector trained by the above-mentioned detector configuring method, target detection on the image to be detected, to obtain a target detection result corresponding to the image to be detected.

According to the embodiment of the present disclosure, target detection is carried out by utilizing a depth learning network with a dilation rate structure, targets with multiple scales can be accurately detected at the same time, and the time required for multi-scale target detection can be shortened on the premise of ensuring the accuracy of target detection, so that the method can be suitable for the real-time scenarios of the multi-scale target detection. For example, the embodiment of the present disclosure can be suitable for detection for vehicles and pedestrians of different sizes at different distances during automatic driving, for key frame detection in real-time intelligent video analysis, for pedestrian detection in security monitoring, for living body detection in intelligent home and the like.

It is to be understood that each of the above-mentioned method embodiments referred to in this disclosure may be combined with one another to form combined embodiments without departing from the underlying logic, and that this disclosure will not be detailed due to space limitations.

It will be appreciated by a person skilled in the art that in the above-mentioned method embodiments, the order in which the various steps are written is not meant to be a strict order of execution but rather constitutes any limitation on the implementation, and that the particular order in which the steps are performed should be determined by their function and possibly by their inherent logic.

In addition, the present disclosure also provides a detector configuring apparatus, an object detection apparatus, an electronic device, a computer-readable storage medium, and a program. The corresponding technical solutions and description as well as the corresponding description with reference to the method section shall not be described in details.

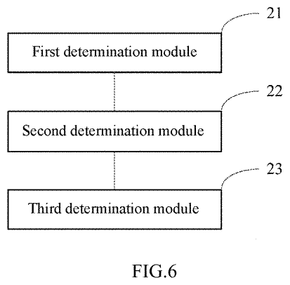

FIG. 6 is a block diagram showing a detector configuring apparatus provided by an embodiment of the present disclosure. As shown in FIG. 6, the detector configuring apparatus includes: a first determination module 21 used for determining a fixed dilation rate of a convolution operation for performing dilation convolution in a detector; a second determination module 22 used for: for any convolution operation for performing dilation convolution in the detector, if the fixed dilation rate of the convolution operation satisfies a decomposition condition, decomposing the convolution operation into a first sub-convolution operation and a second sub-convolution operation, determining an upper limit dilation rate and a lower limit dilation rate corresponding to the fixed dilation rate of the convolution operation, and taking the upper limit dilation rate as the dilation rate of the first sub-convolution operation and the lower limit dilation rate as the dilation rate of the second sub-convolution operation; and a third determination module 23 used for determining the number of output channels corresponding to the first sub-convolution operation and the number of output channels corresponding to the second sub-convolution operation according to the number of output channels of the convolution operation and the fixed dilation rate of the convolution operation.

In one possible implementation, the detector includes a subject network, and the convolution operation for performing dilation convolution in the detector includes: one or more convolution operations in which an original convolution kernel size is a designated size in the subject network of the detector.

In one possible implementation, the detector further includes a dilation rate learner; the first determination module 21 includes: a first determination sub-module used for obtaining a first dilation rate of the convolution operation for a plurality of training images through the dilation rate learner; and a second determination sub-module used for determining the fixed dilation rate of the convolution operation according to the first dilation rate.

In one possible implementation, the dilation rate learner includes a global average pooling layer and a fully connected layer.

In one possible implementation, the first determination sub-module is used for: for any training image in the plurality of training images, obtaining a second dilation rate of the convolution operation for the training image through the dilation rate learner; obtaining a target detection result corresponding to the training image based on the second dilation rate; updating parameters of the dilation rate learner according to the target detection result corresponding to the training image; and obtaining the first dilation rate of the convolution operation for the training image through the parameter-updated dilation rate learner.

In one possible implementation, the second determination sub-module is used for determining the average value of the first dilation rate as the fixed dilation rate of the convolution operation.

In one possible implementation, the fixed dilation rate of the convolution operation satisfying the decomposition condition includes any one of the following: the fixed dilation rate of the convolution operation being a decimal; the minimum distance between the fixed dilation rate of the convolution operation and an integer being greater than a first threshold value, wherein the minimum distance between the fixed dilation rate of the convolution operation and the integer represents a distance between the fixed dilation rate of the convolution operation and the integer closest to the fixed dilation rate of the convolution operation.

In one possible implementation, the second determination module 22 includes: a third determination sub-module used for determining an integer greater than the fixed dilation rate of the convolution operation and closest to the fixed dilation rate of the convolution operation as the upper limit dilation rate corresponding to the fixed dilation rate of the convolution operation; and a fourth determination sub-module used for determining an integer smaller than the fixed dilation rate of the convolution operation and closest to the fixed dilation rate of the convolution operation as the lower limit dilation rate corresponding to the fixed dilation rate of the convolution operation.

In one possible implementation, the third determination module 23 includes: a fifth determination sub-module used for determining an overall difference coefficient corresponding to the convolution operation according to a difference between the fixed dilation rate of the convolution operation and the lower limit dilation rate; and a sixth determination sub-module used for determining the number of output channels corresponding to the first sub-convolution operation and the number of output channels corresponding to the second sub-convolution operation according to the number of output channels of the convolution operation and the overall difference coefficient corresponding to the convolution operation.

In one possible implementation, the apparatus also includes: a training module used for training the detector with a target training image set to optimize parameters of the detector.

The embodiment of the disclosure also provides a target detection apparatus, which includes: an acquisition module used for acquiring an image to be detected; and a target detection module used for performing, by using the detector trained by the above-mentioned detector configuring apparatus, target detection on the image to be detected, to obtain a target detection result corresponding to the image to be detected.

In some embodiments, the functions of the apparatus provided by the embodiments of the present disclosure or the modules included therein may be used to perform the method described in the method embodiment above, and specific implementations thereof may be made with reference to the description of the method embodiment above, which will not be described in details herein for the sake of brevity.

The embodiment of the present disclosure also provides a computer-readable storage medium having stored thereon computer program instructions that, when executed by a processor, implement the methods described above. The computer-readable storage medium may be a nonvolatile computer-readable storage medium or a volatile computer-readable storage medium.

The embodiment of the present disclosure also provides a computer program comprising computer readable codes that, when run in an electronic device, are executed by a processor in the electronic device for implementing the method described above.

The embodiment of the disclosure also provides an electronic device, comprising: one or more processors; and a memory associated with the one or more processors for storing executable instructions that, when read for execution by the one or more processors, perform the method described above.

The electronic device may be provided as a terminal, a server or other form of device.

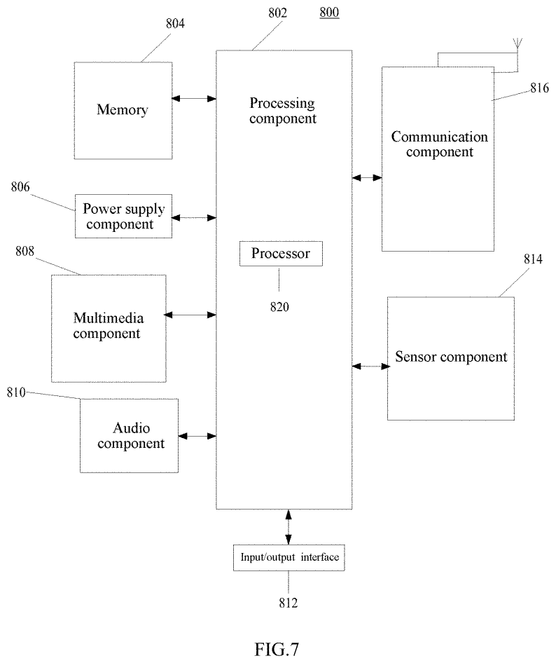

FIG. 7 is a block diagram showing an electronic device 800 provided by an embodiment of the present disclosure. For example, the electronic device 800 may be a mobile phone, a computer, a digital broadcast terminal, a messaging device, a game console, a tablet device, a medical device, an exercise device, a personal digital assistant, or the like.

Referring to FIG. 7, the electronic device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operation of the electronic device 800, such as operations associated with display, telephone calls, data communications, camera operations, and recording operations. The processing component 802 may include one or more processors 820 to execute instructions to perform all or part of the steps of the method described above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store data of various types to support operations at the electronic device 800. Examples of such data include instructions for any application or method operating on the electronic device 800, contact data, phonebook data, messages, pictures, videos, etc. The memory 804 may be implemented by any type of volatile or nonvolatile memory device or combinations thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic or an optical disk.

The power supply component 806 provides power to the various components of the electronic device 800. The power supply components 806 may include a power management system, one or more power sources, and other components associated with generating, managing, and distributing power to the electronic device 800.

The multimedia component 808 includes a screen that provides an output interface between the electronic device 800 and a user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, slips, and gestures on the touch panel. The touch sensor may not only sense the boundaries of a touch or sliding action, but also detect the duration and pressure associated with the touch or sliding operation. In some embodiments, the multimedia component 808 includes a front camera and/or a rear camera. When the electronic device 800 is in an operating mode, such as a shooting mode or a video mode, the front camera and/or the rear camera may receive external multimedia data. Each of the front and rear cameras may be a fixed optical lens system or have focal length and optical zoom capabilities.

The audio component 810 is configured to output and/or input audio signals. For example, the audio component 810 includes a microphone (MIC) configured to receive external audio signals when the electronic device 800 is in an operation mode, such as a call mode, a record mode, and a voice recognition mode. The received audio signal may be further stored in a memory 804 or transmitted via a communication component 816. In some embodiments, the audio component 810 also includes a speaker for outputting audio signals.

The I/O interface 812 provides an interface between the processing component 802 and peripheral interface modules, which may be keyboards, click wheels, buttons, etc. These buttons may include, but are not limited to: home button, volume button, start button, and lock button.

The sensor component 814 includes one or more sensors for providing status assessments of various aspects of the electronic device 800. For example, the sensor component 814 can detect the on/off state of the electronic device 800, the relative positioning of the components, such as a display and keypad of the electronic device 800, the sensor component 814 can also detect a change in the position of the electronic device 800 or one of the components of the electronic device 800, the presence or absence of user contact with the electronic device 800, the orientation or acceleration/deceleration of the electronic device 800, and a change in temperature of the electronic device 800. The sensor component 814 may include a proximity sensor configured to detect the presence of a nearby object in the absence of any physical contact. The sensor component 814 may also include a light sensor, such as a CMOS or CCD image sensor, for use in imaging applications. In some embodiments, the sensor component 814 may also include an acceleration sensor, a gyro sensor, a magnetic sensor, a pressure sensor, or a temperature sensor.

The communication component 816 is configured to facilitate wired or wireless communication between the electronic device 800 and other devices. The electronic device 800 may access a wireless network based on a communication standard, such as Wi-Fi, 2G, 3G, 4G/LTE, 5G, or a combination thereof. In one exemplary embodiment, the communication component 816 receives broadcast signals or broadcast-related information from an external broadcast management system via a broadcast channel. In one exemplary embodiment, the communication component 816 also includes a near field communication (NFC) module to facilitate short-range communication. For example, the NFC module may be implemented based on Radio Frequency Identification (RFID) technology, Infrared Data Association (IrDA) technology, Ultra Wide Band (UWB) technology, Bluetooth (BT) technology, and other technologies.

In an exemplary embodiment, the electronic device 800 may be implemented by one or more application specific integrated circuits (ASICs), digital signal processors (DSPs), digital signal processing device (DSPDs), programmable logic device (PLDs), field programmable gate arrays (FPGAs), controllers, microcontrollers, microprocessors, or other electronic components for performing the methods described above.

In an exemplary embodiment, there is also provided a non-volatile computer-readable storage medium, such as memory 804, comprising computer program instructions executable by the processor 820 of the electronic device 800 to perform the methods described above.

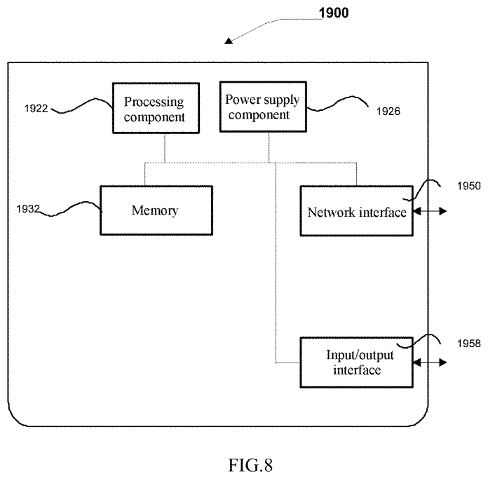

FIG. 8 is a block diagram showing an electronic device 1900 provided by an embodiment of the present disclosure. For example, the electronic device 1900 may be provided as a server. Referring to FIG. 8, the electronic device 1900 includes a processing component 1922, which further includes one or more processors, and memory resources represented by a memory 1932 for storing instructions, such as application programs, executable by the processing component 1922. Applications stored in the memory 1932 may include one or more modules each corresponding to a set of instructions. In addition, the processing component 1922 is configured to execute instructions to perform the methods described above.

The electronic device 1900 may also include a power supply component 1926 configured to perform power management for the electronic device 1900, a wired or wireless network interface 1950 configured to connect the electronic device 1900 to a network, and an input output (I/O) interface 1958. The electronic device 1900 may operate based on an operating system stored in the memory 1932, such as Windows Server®, Mac OS X®, Unix®, Linux®, FreeBSD®, or the like.

In an exemplary embodiment, there is also provided a non-volatile computer-readable storage medium, such as the memory 1932, including computer program instructions executable by the processing component 1922 of the electronic device 1900 to implement the methods described above.

The present disclosure may be a system, method, and/or computer program product. The computer program product may include a computer-readable storage medium having computer-readable program instructions embodied thereon for causing a processor to implement various aspects of the present disclosure.

A computer-readable storage medium may be a tangible device that may hold and store instructions for use by an instruction execution device. The computer-readable storage medium may be, for example but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanical coding device, such as a punch card or a bump-in-groove structure having instructions stored thereon, and any suitable combination of the foregoing. As used herein, a computer-readable storage medium is not to be construed as an instantaneous signal itself, such as a radio wave or other freely propagating electromagnetic wave, an electromagnetic wave propagating through a waveguide or other transmission medium (e.g., an optical pulse through a fiber optic cable), or an electrical signal transmitted through an electrical wire.

The computer readable program instructions described herein may be downloaded from a computer readable storage medium to various computing/processing devices or to an external computer or external storage device over a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives computer readable program instructions from the network and forwards the computer readable program instructions for storage in a computer readable storage medium in the respective computing/processing device.

Computer program instructions for performing operations of the present disclosure may be assembly instructions, instruction set architecture (ISA) instructions, machine instructions, machine-related instructions, microcode, firmware instructions, state setting data, or source or object codes written in any combination of one or more programming languages, including object-oriented programming languages such as Smalltalk, C++, etc. and conventional procedural programming languages, such as the “C” language or similar programming languages. The computer readable program instructions may execute entirely on a user computer, partially on a user computer, as a stand-alone software package, partially on a user computer and partially on a remote computer, or entirely on a remote computer or server. In the case of a remote computer, the remote computer may be connected to the user's computer through any kind of network, including a local area network (LAN) or a wide area network (WAN), or may be connected to an external computer (e.g., through the Internet using an Internet service provider). In some embodiments, various aspects of the present disclosure are implemented by personalizing an electronic circuit, such as a programmable logic circuit, a field programmable gate array (FPGA), or a programmable logic array (PLA), using state information of computer-readable program instructions that can execute the computer-readable program instructions.

Various aspects of the disclosure are described herein with reference to flowchart and/or block diagrams of methods, apparatus (systems), and computer program products according to the embodiments of the disclosure. It will be understood that each block of the flowchart and/or block diagrams, and combinations of blocks in the flowchart and/or block diagrams, can be implemented by computer readable program instructions.

These computer-readable program instructions may be provided to a processor of a general purpose computer, a special purpose computer, or other programmable data processing device to produce a machine, such that the instructions, when executed by the processor of the computer or other programmable data processing device, produce an apparatus for implementing the functions/acts specified in the flowchart and/or block diagram block or blocks. The computer-readable program instructions may also be stored in a computer-readable storage medium that causes a computer, a programmable data processing apparatus, and/or other apparatus to function in a particular manner, such that the computer-readable medium in which the instructions are stored comprises an article of manufacture including instructions that implement various aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process such that the instructions which execute on the computer, other programmable data processing apparatus or other device, implement the functions/acts specified in the flowchart and/or one or more blocks in the block diagram.

The flowcharts and block diagrams in the drawings illustrate the architecture, functionality, and operation of possible implementations of systems, methods, and computer program products in accordance with various embodiments of the present disclosure. In this regard, each block of the flowchart or block diagrams may represent a module, segment, or portion of an instruction, which comprises one or more executable instructions for implementing the specified logical function(s). In some alternative implementations, the functions noted in the blocks may occur out of the order noted in the figures. For example, two consecutive blocks may in fact be executed substantially in parallel, and they may sometimes be executed in the reverse order, depending on the functionality involved. It is also noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Having described the embodiments of the present disclosure, the foregoing description is illustrative, not exhaustive, and is not limited to the disclosed embodiments. Many modifications and variations will be apparent to a person skilled in the art without departing from the scope and spirit of the described embodiments. The choice of terminology used herein is intended to best explain the principles of the embodiments, practical applications, or technical modifications to the technology in the marketplace, or to enable other persons skilled in the art to understand the embodiments disclosed herein.

1. A detector configuring method, comprising:
determining a fixed dilation rate of a convolution operation for performing dilation convolution in a detector;
for any convolution operation for performing dilation convolution in the detector, in response to the fixed dilation rate of the convolution operation satisfying a decomposition condition, decomposing the convolution operation into a first sub-convolution operation and a second sub-convolution operation, determining an upper limit dilation rate and a lower limit dilation rate corresponding to the fixed dilation rate of the convolution operation, wherein the upper limit dilation rate is a dilation rate of the first sub-convolution operation, and the lower limit dilation rate is a dilation rate of the second sub-convolution operation; and
determining a number of output channels corresponding to the first sub-convolution operation and a number of output channels corresponding to the second sub-convolution operation according to a number of output channels of the convolution operation and the fixed dilation rate of the convolution operation.

2. The method according to claim 1, wherein the detector comprises a subject network, the convolution operation for performing dilation convolution in the detector comprises:
one or more convolution operations in which an original convolution kernel size is a designated size in the subject network of the detector.

3. The method according to claim 1, wherein the detector further comprises a dilation rate learner;
determining the fixed dilation rate of the convolution operation for performing dilation convolution in the detector comprises:
obtaining a first dilation rate of the convolution operation for a plurality of training images through the dilation rate learner; and
determining the fixed dilation rate of the convolution operation according to the first dilation rate.

4. The method according to claim 3, wherein the dilation rate learner comprises a global average pooling layer and a fully connected layer.

5. The method according to claim 3, wherein obtaining the first dilation rate of the convolution operation for the plurality of training images through the dilation rate learner comprises:
for any training image in the plurality of training images, obtaining a second dilation rate of the convolution operation for the training image through the dilation rate learner;
obtaining a target detection result corresponding to the training image based on the second dilation rate;
updating parameters of the dilation rate learner according to the target detection result corresponding to the training image; and
obtaining the first dilation rate of the convolution operation for the training image through the parameter-updated dilation rate learner.

6. The method according to claim 3, wherein determining the fixed dilation rate of the convolution operation according to the first dilation rate comprises:
determining an average value of the first dilation rate as the fixed dilation rate of the convolution operation.

7. The method according to claim 1, wherein the fixed dilation rate of the convolution operation satisfying a decomposition condition comprises any one of:
the fixed dilation rate of the convolution operation being a decimal;
the minimum distance between the fixed dilation rate of the convolution operation and an integer being greater than a first threshold value, wherein the minimum distance between the fixed dilation rate of the convolution operation and the integer represents a distance between the fixed dilation rate of the convolution operation and the integer closest to the fixed dilation rate of the convolution operation.

8. The method according to claim 1, wherein determining the upper limit dilation rate and the lower limit dilation rate corresponding to the fixed dilation rate of the convolution operation comprises:
determining an integer greater than the fixed dilation rate of the convolution operation and closest to the fixed dilation rate of the convolution operation as the upper limit dilation rate corresponding to the fixed dilation rate of the convolution operation; and
determining an integer smaller than the fixed dilation rate of the convolution operation and closest to the fixed dilation rate of the convolution operation as the lower limit dilation rate corresponding to the fixed dilation rate of the convolution operation.

9. The method according to claim 1, wherein determining the number of output channels corresponding to the first sub-convolution operation and the number of output channels corresponding to the second sub-convolution operation according to the number of output channels of the convolution operation and the fixed dilation rate of the convolution operation comprises:
determining an overall difference coefficient corresponding to the convolution operation according to a difference between the fixed dilation rate of the convolution operation and the lower limit dilation rate; and
determining the number of output channels corresponding to the first sub-convolution operation and the number of output channels corresponding to the second sub-convolution operation according to the number of output channels of the convolution operation and the overall difference coefficient corresponding to the convolution operation.

10. The method according to claim 1, further comprising after determining of the number of output channels corresponding to the first sub-convolution operation and the number of output channels corresponding to the second sub-convolution operation:
training the detector with a target training image set to optimize parameters of the detector.

11. A detector configuring apparatus, comprising:
a processor; and
a memory configured to store processor-executable instructions,
wherein the processor is configured to invoke the instructions stored in the memory, so as to:
determine a fixed dilation rate of a convolution operation for performing dilation convolution in a detector;
for any convolution operation for performing dilation convolution in the detector, in response to the fixed dilation rate of the convolution operation satisfying a decomposition condition, decomposing the convolution operation into a first sub-convolution operation and a second sub-convolution operation, determining an upper limit dilation rate and a lower limit dilation rate corresponding to the fixed dilation rate of the convolution operation, wherein the upper limit dilation rate is a dilation rate of the first sub-convolution operation, and the lower limit dilation rate is a dilation rate of the second sub-convolution operation; and
determine a number of output channels corresponding to the first sub-convolution operation and a number of output channels corresponding to the second sub-convolution operation according to a number of output channels of the convolution operation and the fixed dilation rate of the convolution operation.

12. The apparatus according to claim 11, wherein the detector comprises a subject network, and the convolution operation for performing dilation convolution in the detector comprises:
one or more convolution operations in which an original convolution kernel size is a designated size in the subject network of the detector.

13. The apparatus according to claim 11, wherein the detector further comprises a dilation rate learner;
determining the fixed dilation rate of the convolution operation for performing dilation convolution in the detector comprises the first determination module comprises:
obtaining a first dilation rate of the convolution operation for a plurality of training images through the dilation rate learner; and
determining the fixed dilation rate of the convolution operation according to the first dilation rate.

14. The apparatus according to claim 13, wherein the dilation rate learner comprises a global average pooling layer and a fully connected layer.

15. The apparatus according to claim 13, wherein obtaining the first dilation rate of the convolution operation for the plurality of training images through the dilation rate learner comprises:
for any training image in the plurality of training images, obtaining a second dilation rate of the convolution operation for the training image through the dilation rate learner;
obtaining a target detection result corresponding to the training image based on the second dilation rate;
updating parameters of the dilation rate learner according to the target detection result corresponding to the training image; and
obtaining the first dilation rate of the convolution operation for the training image through the parameter-updated dilation rate learner.

16. The apparatus according to claim 13, wherein determining the fixed dilation rate of the convolution operation according to the first dilation rate comprises:
determining an average value of the first dilation rate as the fixed dilation rate of the convolution operation.

17. The apparatus according to claim 11, wherein the fixed dilation rate of the convolution operation satisfying a decomposition condition comprises any one of:
the fixed dilation rate of the convolution operation being a decimal;
the minimum distance between the fixed dilation rate of the convolution operation and an integer being greater than a first threshold value, wherein the minimum distance between the fixed dilation rate of the convolution operation and the integer represents a distance between the fixed dilation rate of the convolution operation and the integer closest to the fixed dilation rate of the convolution operation.

18. The apparatus according to claim 11, wherein determining the upper limit dilation rate and the lower limit dilation rate corresponding to the fixed dilation rate of the convolution operation comprises:
determining an integer greater than the fixed dilation rate of the convolution operation and closest to the fixed dilation rate of the convolution operation as the upper limit dilation rate corresponding to the fixed dilation rate of the convolution operation; and
determining an integer smaller than the fixed dilation rate of the convolution operation and closest to the fixed dilation rate of the convolution operation as the lower limit dilation rate corresponding to the fixed dilation rate of the convolution operation.

19. The apparatus according to claim 11, wherein determining the number of output channels corresponding to the first sub-convolution operation and the number of output channels corresponding to the second sub-convolution operation according to the number of output channels of the convolution operation and the fixed dilation rate of the convolution operation comprises:
determining an overall difference coefficient corresponding to the convolution operation according to a difference between the fixed dilation rate of the convolution operation and the lower limit dilation rate; and
determining the number of output channels corresponding to the first sub-convolution operation and the number of output channels corresponding to the second sub-convolution operation according to the number of output channels of the convolution operation and the overall difference coefficient corresponding to the convolution operation.

20. A non-transitory computer readable storage medium having stored thereon computer program instructions, wherein the computer program instructions, when executed by a processor, the processor is caused to perform the operations of:
determining a fixed dilation rate of a convolution operation for performing dilation convolution in a detector;
for any convolution operation for performing dilation convolution in the detector, in response to the fixed dilation rate of the convolution operation satisfying a decomposition condition, decomposing the convolution operation into a first sub-convolution operation and a second sub-convolution operation, determining an upper limit dilation rate and a lower limit dilation rate corresponding to the fixed dilation rate of the convolution operation, wherein the upper limit dilation rate is a dilation rate of the first sub-convolution operation, and the lower limit dilation rate is a dilation rate of the second sub-convolution operation; and
determining a number of output channels corresponding to the first sub-convolution operation and a number of output channels corresponding to the second sub-convolution operation according to a number of output channels of the convolution operation and the fixed dilation rate of the convolution operation.
